(19) United States
(12) Patent Application Publication
(10) Pub. No.: US 2022/0332237 A1
(43) Pub. Date: Oct. 20, 2022

(54) LIGHTWEIGHT TRAY WITH PNEUMATIC CUSHIONING SYSTEM

(71) Applicant: MIS.CARBONART PTY LTD, Applecross (AU)

(72) Inventors: Alexander VINCAN, Mosman Park (AU); Yue SUN, Thornlie (AU); Gary Charles STRICKLAND, Kalamunda (AU)

(73) Assignee: MIS.CARBONART PTY LTD, Applecross (AU)

(21) Appl. No.: 17/641,097

(22) PCT Filed: Jul. 24, 2020
(86) PCT No.: PCT/AU2020/050762

§ 371 Date: Mar. 8, 2022

(30) Foreign Application Priority Data
Jul. 24, 2019 (AU) 2019902623

(51) Int. Cl. B60P 1/28; B60P 1/04; B60P 1/16; B60G 17/015

(52) U.S. Cl. CPC B60P 1/286; B60P 1/045; B60P 1/16; B60G 17/0155; B60G 2204/148; B60G 2300/02

(57) ABSTRACT

A haul truck dump tray with a pneumatic shock absorption system is provided. The haul truck dump tray includes a first longitudinal body portion and a second longitudinal body portion joined along a center line by an interposing elastomeric link extending along the center line and bonded to and between them. The haul truck dump tray includes a topside support member joined along the center line by the interposing elastomeric link to the first longitudinal body portion and the second longitudinal body portion. The haul truck dump tray includes a bottomside support member joined along the center line by the interposing elastomeric link to the first longitudinal body portion and the second longitudinal body portion. The resulting haul truck dump tray has improved weight, strength, and durability characteristics.

### PRIORITY CLAIM AND CROSS-REFERENCE TO RELATED APPLICATIONS

This application is a National Phase of PCT/AU2020/050762 filed Jan. 28, 2021, which claims benefit of and priority to Australia Provisional Patent Application AUSN 2019902623 filed Jul. 24, 2019, titled LIGHTWEIGHT TRAY WITH PNEUMATIC CUSHIONING SYSTEM, which is hereby incorporated by reference in its entirety, to the extent it is not inconsistent herewith.

This application incorporates by reference in its entirety, to the extent it is not inconsistent herewith, Australia Provisional Patent Application AUSN 2019902624 filed Jul. 24, 2019, titled METHOD FOR CREATING AN ADHESIVE BOND USING AN ELASTOMERIC MATERIAL; Australia Provisional Patent Application AUSN 2019902625 filed Jul. 24, 2019, titled ENERGY-DISSIPATIVE PNEUMATIC CUSHIONING SYSTEM; and Australia Provisional Patent Application AUSN 2019902628 filed Jul. 24, 2019, titled METHOD FOR APPLYING A PROTECTIVE COATING TO A HAUL TRUCK TRAY.

### BACKGROUND

Haul trucks are heavy vehicles specifically engineered for use in high-production mining and heavy-duty construction environments. Haul truck components include a chassis, and a tray for accepting, carrying, and offloading heavy loads. The tray is often made largely of steel, contributing significantly to the overall weight of the haul truck, with corresponding negative effects on fuel efficiency and hauling capacity.

High impact forces and uneven weight distribution during loading and/or transport contributes to wear and tear on many components of a haul truck, including the chassis and tray, and failure of haul truck components represents a safety risk for operators of these trucks.

### SUMMARY

In view of the foregoing, embodiments herein disclose a haul truck dump tray design that is lightweight, durable, and that promotes even weight distribution under load. The haul truck dump tray designs disclosed and claimed herein provide for a safer and more efficient tray and haul truck.

The presently disclosed and claimed haul truck tray designs include, for example, a first longitudinal tray body portion and a second longitudinal tray body portion joined along a center line by an interposing elastomeric link extending along the center line and bonded to and between them. In some embodiments, the haul truck dump tray may include a topside support member joined along the center line by the interposing elastomeric link to the first and second longitudinal body portions. The haul truck dump tray may also include a bottomside support member joined along the center line by the interposing elastomeric link to the first and second longitudinal body portions. In some embodiments, the topside support member and the bottomside support member are attached to each other by a vertical connector to form an integral I-beam shaped support structure between the first longitudinal tray body portion and the second longitudinal tray body portion, i.e., the two halves of the tray. As discussed above, elastomeric bonding may be employed to hold the two halves of the tray together, e.g., attached via an elastomeric link to the integral I-beam shaped support structure.

The embodiments herein mitigate the effects of uneven weight distribution and high impact forces during loading and unloading of the haul truck dump tray, and provide a lightweight tray that improves the weight distribution of loads on the haul truck dump tray, thereby enhancing the stability and the structural integrity of the haul truck dump tray. Further, the first longitudinal body portion and the second longitudinal body portion may include a foam core covered by one or more carbon fiber polymer surface layers. The carbon fiber polymer is lightweight and corrosion resistant, and provides high tensile strength. The foam core provides additional rigidity. The topside support member and the bottomside support member may be made of a carbon fiber composite material or metal. Properties of carbon fiber composite material include high stiffness and strength, reduced weight compared with, e.g., steel, and corrosion resistance, which properties taken together increase the structural integrity and strength of the haul truck dump tray.

The haul truck dump tray may include a polymer canopy portion bonded to a top front edge portion of the first longitudinal body portion and the second longitudinal body portion by an interposing elastomeric link. The interposing elastomeric link may extend across a width of the joined first longitudinal body portion and the second longitudinal body portion. The polymer canopy portion may be bonded by an interposing elastomeric link to the topside support member and the bottomside support member. A canopy joining member may interpose the polymer canopy portion and the first longitudinal body portion and the second longitudinal body portion to facilitate elastomeric bonding, e.g., to provide additional surface area for bonding.

In some embodiments, an interposing elastomeric link joins the polymer canopy portion, the canopy joining member, the first longitudinal body portion, and the second longitudinal body portion. The interposing elastomeric link may include polyurethane. In some embodiments, the elastomeric link is formed by curing of a polyurethane applied in fluid form. A polyurethane elastomeric link has both strength and flexibility as a bonding agent, helping to both hold parts together and dissipate shock energy throughout the tray structure.

In some embodiments, the canopy joining member includes an elongate body. The elongate body may include a first channel or groove positioned to receive joining portions respectively of the first longitudinal body portion and the second longitudinal body portion. The canopy joining member may include a second channel or a groove positioned to receive a joining portion of the polymer canopy portion. In some embodiments, the polymer canopy portion, the canopy joining member, the first longitudinal body portion, and the second longitudinal body portion are joined via interposing elastomeric links.

In some embodiments, the polymer canopy portion includes a low-density foam core. The low-density foam core may include a surface that is covered by a layer of carbon fiber composite material. The carbon fiber composite material may include an aerospace grade carbon fiber composite material or an industrial grade carbon fiber composite material.

In some embodiments, the haul truck dump tray includes a wear liner. The wear liner may include an elastomeric material. The elastomeric material may include cast polyurethane. In some embodiments, the elastomeric material may include a polyurethane wear liner of about 90 mm to 100 mm in thickness.

The first longitudinal body portion and the second longitudinal body portion may comprise substantially two respective longitudinal halves of the haul truck dump tray. Each of the two longitudinal halves may include carbon fiber polymer tray portions including substantially matching edges, and joined along the matching edges by an interposing elastomeric link extending along the matching edges and bonded to and between them. The first longitudinal body portion and the second longitudinal body portion when joined together may form the floor of the haul truck dump tray, the front wall of the haul truck dump tray, and the side walls of the haul truck dump tray.

In one aspect, the haul truck dump tray includes (a) a carbon fiber composite and foam core composite structure lined with an elastomeric material, (b) a canopy, (c) a pivot assembly, and (d) a hoist assembly.

The haul truck dump tray may include a compression-resistant support frame extending beneath the haul truck dump tray and include at least one mount via which the haul truck dump tray assembly can be pivotally attached to the support frame and/or a haul truck chassis, and at least one cushioning element interposing the haul truck dump tray and the support frame.

In another aspect, the haul truck dump tray includes (a) a first longitudinal body portion and a second longitudinal body portion and (b) a continuous elastomeric link. The first longitudinal body portion and the second longitudinal body portion may each include (i) a top carbon fiber laminate surface; (ii) an opposing bottom carbon fiber laminate surface; (iii) a foam core that is disposed between the top carbon fiber laminate surface and the opposing bottom carbon fiber laminate surface; (iv) at least one angled portion proximate to a center line of the haul truck dump tray; (v) a topside support member; and (vi) a bottomside support member. The angled portions may together may form a v-shaped cross-section of the bottom of the tray, in which the longitudinal center line of the bottom of the tray forms the bottom of the v-shaped cross-section. In some embodiments, the angle of each half of the tray is 5 degrees above a horizontal plane of the bottom of the tray positioned at the lowest point of the support members. The angled portion of the first longitudinal body portion and the angled portion of the second longitudinal body portion may form a channel at which their edges approach the center line of the haul truck dump tray. The topside support member resides at least partially within the channel and the bottomside support member may be positioned approximately parallel to the topside support member, on the other side of the joined longitudinal body portions. The foam core of the longitudinal body portions may include a low-density foam core and/or a high-density foam core.

In some embodiments, a continuous elastomeric link joins to and between at least (a) the first longitudinal body portion and the second longitudinal body portion along a face of the angled portions; (b) the topside support member, the first longitudinal body portion, and the second longitudinal body portion; and (c) the bottomside support member, the first longitudinal body portion, and the second longitudinal body portion along the center line of the haul truck dump tray. In some embodiments, the elastomeric link comprises an approximate thickness of at least 1 mm. In other embodiments, the elastomeric link may comprise an approximate thickness of at least 2 mm. Or, the elastomeric link may include an approximate thickness of at least 3 mm.

In some embodiments, the top carbon fiber laminate surface and the opposing bottom carbon fiber laminate surface includes at least one high-density foam core between them. The at least one high-density foam core may be positioned and of a thickness sufficient to absorb a concentrated force load relative to other areas of the haul truck dump tray, depending on predicted repeated impact on specific areas of the tray. The haul truck dump tray may include any of: at least one pivot assembly, a hoisting mechanism assembly, and/or a pneumatic compression system.

In some embodiments, the haul truck dump tray includes a compression-resistant support frame extending beneath the haul truck dump tray and having at least one mount via which the haul truck dump tray can be pivotally attached to a haul truck chassis, and at least one cushioning element interposing the haul truck dump tray and the support frame. In some embodiments, the haul truck dump tray includes a canopy joining member. The canopy joining member may interpose the polymer canopy portion and the first longitudinal body portion and the second longitudinal body portion. A continuous elastomeric link may join the polymer canopy portion to the canopy joining member and the first longitudinal body portion and the second longitudinal body portion. In some embodiments, the haul truck dump tray includes at least one tray support structure. The tray support structure may include a welded steel support unit, one or more outrigger attachment points configured to provide roll stabilization support, at least one location for accepting a pivot mechanism connection, and/or at least one location for accepting a hoisting mechanism connection.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1A illustrates an example view of a haul truck with a pneumatic shock absorption system according to some embodiments herein;

FIG. 1B illustrates a perspective view of a haul truck dump tray having the pneumatic shock absorption system according to some embodiments herein;

FIG. 2A illustrates a front view of a tray system of FIG. 1B according to some embodiments herein:

FIG. 2B illustrates a bottom view of the tray system of FIG. 1B according to some embodiments herein:

FIG. 3A illustrates a top view of the tray system of FIG. 1B according to some embodiments herein;

FIG. 3B illustrates a cross sectional view of a polymer canopy portion of FIG. 3A according to some embodiments herein;

FIG. 3C illustrates a cross sectional view of a top edge portion of the tray system of FIG. 3A according to some embodiments herein;

FIG. 3D illustrates a cross sectional view of a bottom edge portion of the tray system of FIG. 3A according to some embodiments herein;

FIGS. 4A and 4B illustrate a side portion and a cross sectional view of the side portion of the tray system of FIG. 2A according to some embodiments herein;

FIG. 4C illustrates a bottom portion of the tray system of FIG. 2A according to some embodiments herein;

FIG. 4D illustrates a bottom view of the tray system of FIG. 2A according to some embodiments herein;

FIG. 5A illustrates a front view of the pneumatic shock absorption system of FIG. 1 according to some embodiments herein;

FIG. 5B illustrates an example view of an elongated compartment with a flange of FIG. 5A according to some embodiments herein;

FIG. 6A illustrates a perspective view of a stabilization and tray support system of FIG. 1 according to some embodiments herein;

FIGS. 6B-6E illustrate example views of components of the stabilization and tray support system of FIG. 1B according to some embodiments herein;

herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein and the subject matter of the claims. Accordingly, the examples should not be construed as limiting the scope of the embodiments herein or the claims of this application.

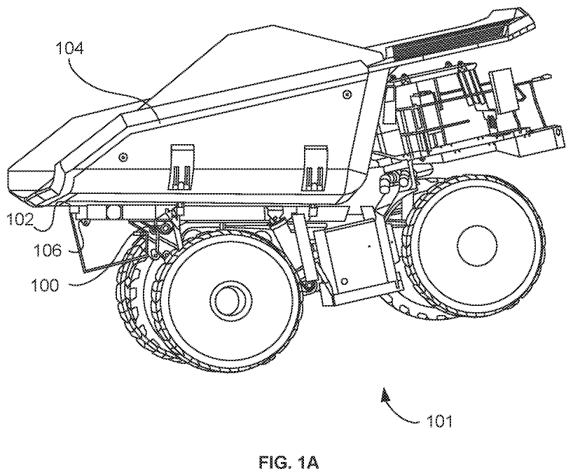

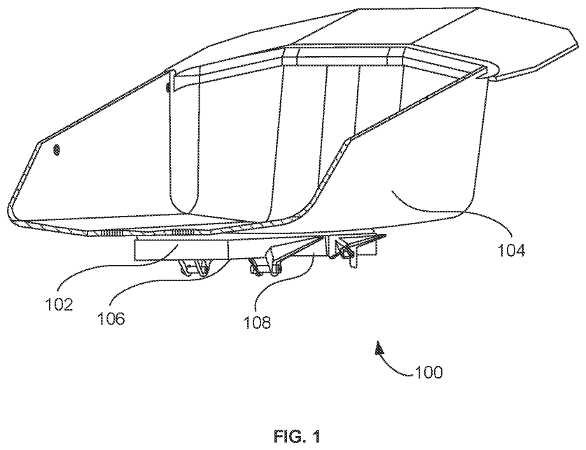

As discussed briefly above, the present inventions relate to lightweight haul truck tray designs and a pneumatic cushioning system for a haul truck, among other things. Referring now to the drawings, and more particularly to FIGS. 1A through 7C, where similar reference characters denote corresponding features consistently throughout the figures, various embodiments are shown.

FIG. 1A illustrates an example view of a haul truck 101 with a pneumatic shock absorption system 102 according to some embodiments herein. The haul truck 101 includes a haul truck dump tray 100, the pneumatic shock absorption system 102, a tray system 104 and a stabilization and tray support system 106. The pneumatic shock absorption system 102 absorbs, mitigates and dampens shock impulses and pressure from the haul truck dump tray 100 in general.

The tray system 104 may include polyurethane bonded joints for shear strength, tensile strength, energy dissipation, and/or durability. The tray system 104 may include a bed connector that connects with the stabilization and tray support system 106. The bed connector may connect with the stabilization and tray support system 106 using one or more bed connector assemblies. The one or more bed connector assemblies may include known mechanisms for connecting the haul truck dump tray 100 to a chassis, including any of chain links, pins, cams, or components of a pivot sub-assembly, and/or a hoist portion. The cams may permit rotation of the haul truck dump tray 100 relative to a pivot point on the chassis of the haul truck 101.

FIG. 1B illustrates a perspective view of the haul truck dump tray 100 having a pneumatic shock absorption system 102 according to some embodiments herein. The haul truck dump tray 100 includes pneumatic shock absorption system 102, tray system 104, and stabilization and tray support system 106. Tray system 104 may include a two-piece carbon fiber laminate tray structure. In some embodiments, tray system 104 has a high and low-density foam core and includes a carbon fiber laminate surface. In some embodiments, the haul truck dump tray 100 includes both carbon fiber and steel components.

Tray system 104 may include a polyurethane surface coating or wear liner that provides resistance from abrasion and surface wear and tear. Stabilization and tray support system 106 includes one or more support members 108 as a tray support structure. In some embodiments, the tray support structure includes a welded steel support unit. The tray support structure may also include at least one location for accepting a pivot mechanism connection and at least one location for accepting a hoisting mechanism connection. In some embodiments, the tray support structure includes one or more attachment points for one or more outriggers that are configured to provide roll stabilization support via attachment means between the tray support structure and the tray itself.

The pneumatic shock absorption system 102 may dissipate at least a portion of the weight from the tray support structure that is above the pneumatic shock absorption system 102. The haul truck dump tray 100 may include a carbon fiber composite and foam core composite structure lined with an elastomeric material, a canopy, a pivot assembly, and a hoisting mechanism assembly. In some embodiments, the haul truck dump tray 100 includes a pneumatic cushioning system.

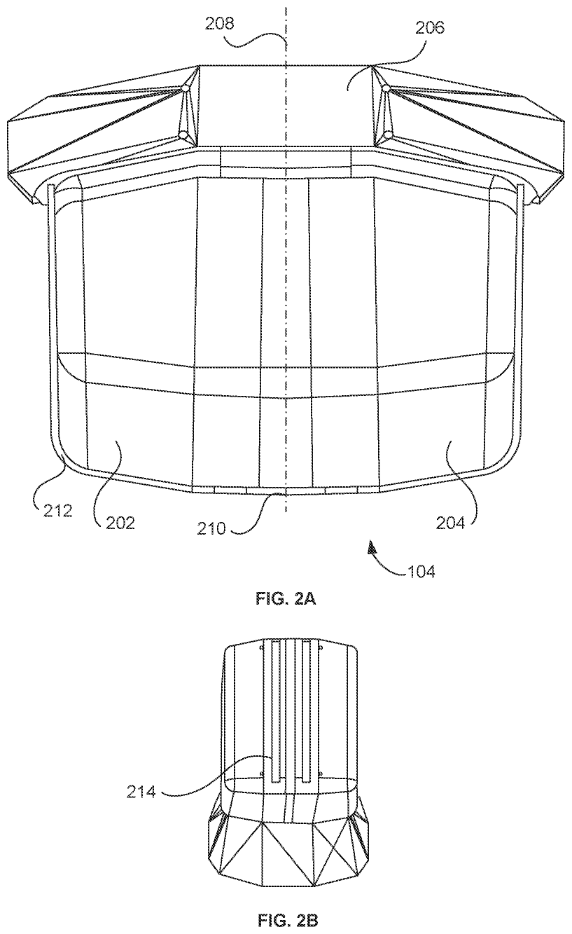

FIG. 2A illustrates a front view of the tray system 104 of FIG. 1 according to some embodiments herein. The tray system 104 includes a first longitudinal body portion 202, a second longitudinal body portion 204, a polymer canopy portion 206, a center line 208, a bottom portion 210 and a side portion 212. The first longitudinal body portion 202 and the second longitudinal body portion 204 are joined along a center line 208 by an interposing elastomeric link extending along the center line 208 and bonded to and between the first longitudinal body portion 202 and the second longitudinal body portion 204. The tray system 104 includes a topside support member that is joined along the center line by the interposing elastomeric link to the first longitudinal body portion 202 and the second longitudinal body portion 204. The tray system 104 includes a bottomside support member that is joined along the center line by the interposing elastomeric link to the first longitudinal body portion 202 and the second longitudinal body portion 204. The interposing elastomeric link may include polyurethane and/or a cast polyurethane. In some embodiments, the interposing elastomeric link is formed by a curing of a polyurethane applied in fluid form. The interposing elastomeric link may include a polyurethane bonding layer of at least 3 mm in thickness. The bottomside support member and/or the topside support member may comprise carbon fiber resin, steel, or other similar material with sufficient rigidity.

In an alternative embodiment, the tray system 104 includes a vertical connector attached to the topside support member and the bottomside composite polymer support member. In some embodiments, the topside composite polymer support member, the vertical connector, and the bottomside support member are joined by a middle support structure to form an I-beam structure. The middle support structure may be a discrete column, series of columns, may be continuous along the length of the topside and bottomside composite polymer support member, and/or may be honeycombed along its length. The I-beam structure may be made up of any of: a composite material, a carbon fiber material, or a metallic material such as steel that may support an elastomeric link along the center line 208 and bonded to and between the first longitudinal body portion 202 and the second longitudinal body portion 204. Two or more I-beam structures may be arranged end-to-end longitudinally along the haul truck dump tray 100 to form a substantially continuous I-beam structure.

The first longitudinal body portion 202 and the second longitudinal body portion 204 may comprise a foam core covered by one or more carbon fiber polymer surface layers. In some embodiments, the foam core is a high-density foam core and/or a low-density foam core. The first longitudinal body portion 202 and the second longitudinal body portion 204 may together form a portion of a floor of the haul truck dump tray 100, a portion of a front wall of the haul truck dump tray 100, and/or a portion of a side wall of the haul truck dump tray 100.

The first longitudinal body portion 202 and/or the second longitudinal body portion 204 may include a top carbon fiber laminate surface, an opposing bottom carbon fiber laminate surface, a foam core, at least one angled portion proximate to the longitudinal center line 208 of the haul truck dump tray 100, a topside support member, a bottomside support member and a discontinuous or continuous elastomeric link. In some embodiments, the foam core is disposed between the top carbon fiber laminate surface and the opposing bottom carbon fiber laminate surface. In some embodiments, the angled portion includes an angled portion of the first longitudinal body portion 202 and an angled portion of the second longitudinal body portion 204. The angled portion of the first longitudinal body portion 202 and the angled portion of the second longitudinal body portion 204 may form a channel as their respective edges meet along the center line 208 of the haul truck dump tray 100. The topside support member may reside at least partially within the channel. The bottomside support member may be positioned approximately parallel to the topside composite support member beneath the joined body portions. In some embodiments, a continuous elastomeric link joins to and between at least (i) the first longitudinal body portion 202 and the second longitudinal body portion 204 along a face of the angled portion; (ii) the topside support member, the first longitudinal body portion 202, and the second longitudinal body portion 204; and (iii) the bottomside support member, the first longitudinal body portion 202, and the second longitudinal body portion 204 along the center line 208 of the haul truck dump tray 100.

The elastomeric link may include a thickness of at least 1 mm. In some embodiments, the elastomeric link includes a thickness of at least 2 mm. In some embodiments, the elastomeric link includes the thickness of at least 3 mm. The top carbon fiber laminate surface and the opposing bottom carbon fiber laminate may include at least one high-density foam core. In some embodiments, the at least one high-density foam core is positioned to absorb or withstand a concentrated force load relative to other areas of the haul truck dump tray 100. In some embodiments, haul truck dump tray 100 includes substantially two respective longitudinal halves. Each of the two longitudinal halves may comprise symmetrical, substantially mirror-image carbon polymer tray portions having substantially matching edges, wherein the two halves are aligned and joined along the matching edges by an interposing elastomeric link extending along the matching edges and bonded to and between them.

FIG. 2B illustrates a bottom view of the tray system 104 according to some embodiments herein. The tray system 104 may include a high-density foam core 214. The high-density foam core 214 is a location where the haul truck dump tray 100 may align with a support frame (not shown) and optionally energy-dissipative pneumatic cushioning system 102 positioned beneath the first longitudinal body portion 202 and the second longitudinal body portion 204.

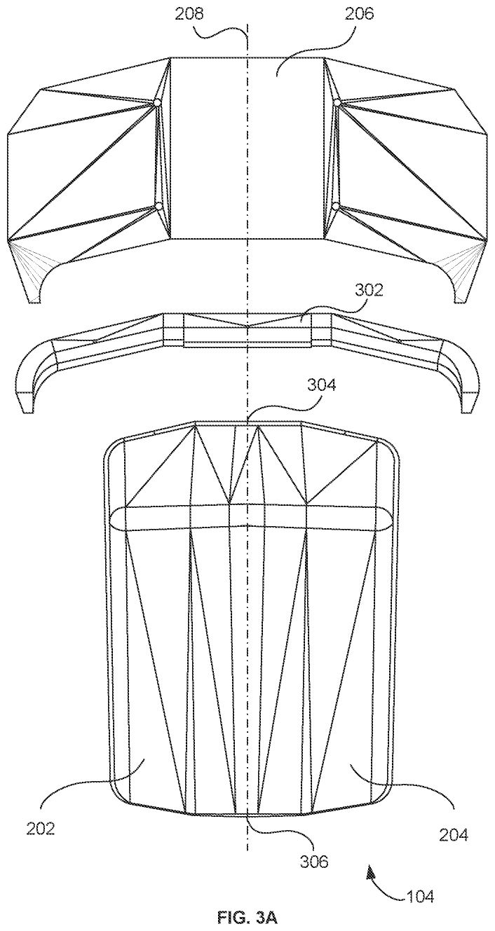

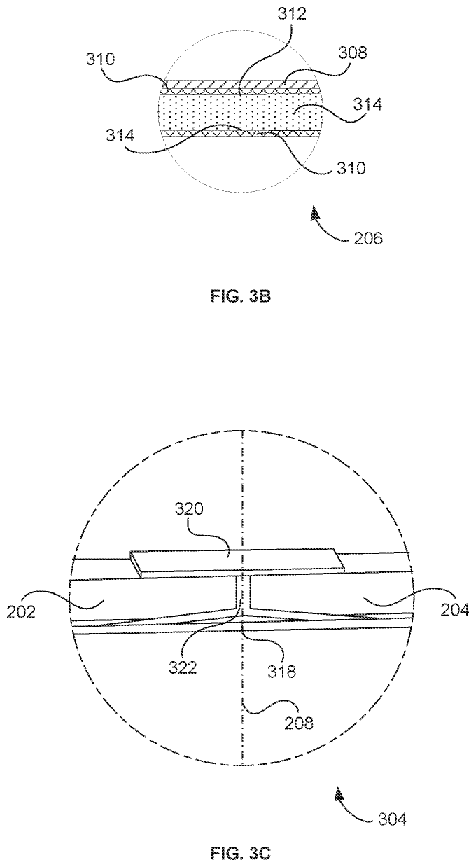

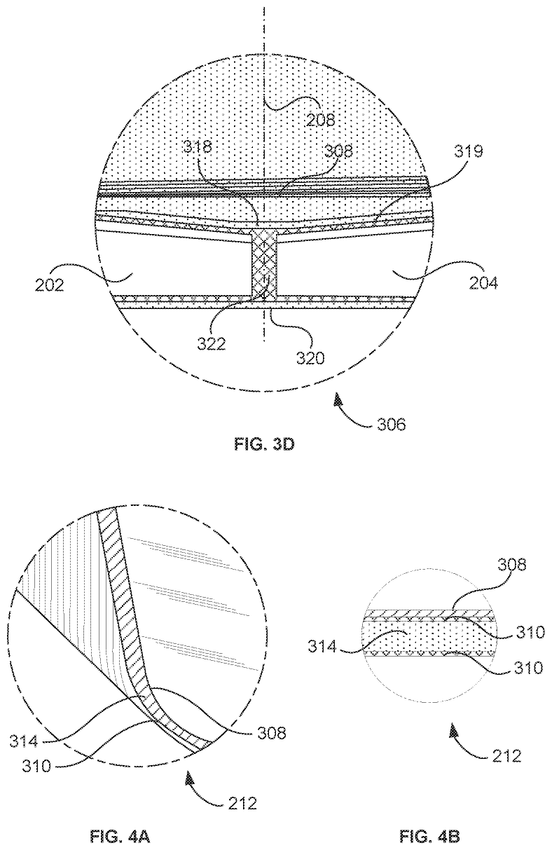

FIG. 3A illustrates a top view of the tray system 104 of FIG. 1 according to some embodiments herein. The tray system 104 includes first longitudinal body portion 202, second longitudinal body portion 204, polymer canopy portion 206, center line 208, canopy joining member 302, top edge portion 304, and bottom edge portion 306. Canopy joining member 302 may include a first channel or groove positioned to receive joining portions respectively of the first longitudinal body portion 202 and the second longitudinal body portion 204 of the tray system 104. In some embodiments, canopy joining member 302 is an optional canopy joining member. Canopy joining member 302 may include an interposing elastomeric link to receive joining portions of the first longitudinal body portion 202 and the second longitudinal body portion 204 of the tray system 104. Canopy joining member 302 interposes polymer canopy portion 206 and the first longitudinal body portion 202 and the second longitudinal body portion 204. The interposing elastomeric link may join polymer canopy portion 206 to each of 1) canopy joining member 302, 2) first longitudinal body portion 202; and 3) second longitudinal body portion 204.

In some embodiments, canopy joining member 302 includes an elongate body including a first channel or groove positioned to receive joining portions respectively of the first longitudinal body portion 202 and the second longitudinal body portion 204 of the tray system 104. Canopy joining member 302 may include a second channel or groove positioned to receive a joining portion of polymer canopy portion 206.

Polymer canopy portion 206 may be bonded to top edge portion 304 of the first longitudinal body portion 202 and the second longitudinal body portion 204 by an interposing elastomeric link that extends across a width of the joined first longitudinal body portion 202 and second longitudinal body portion 204. In some embodiments, polymer canopy member 206 includes a low-density foam core with a surface area portion covered by a layer of a carbon fiber composite material. In some embodiments, polymer canopy portion 206, canopy joining member 302, first longitudinal body portion 202, and second longitudinal body portion 204 are all joined via the interposing elastomeric links.

FIG. 3B illustrates a cross sectional view of the polymer canopy portion 206 of FIG. 3A according to some embodiments herein. The polymer canopy portion 206 includes a wear liner 308, a carbon fiber composite material 310, a first surface area 312, low-density foam core 314, and a second surface area 316. Wear liner 308 may comprise an elastomeric material. The elastomeric material may include cast polyurethane. In some embodiments, wear liner 308 is a polyurethane wear liner. The carbon fiber composite material 310 may include an aerospace grade carbon fiber composite material or an industrial grade carbon fiber composite material. The first surface area 312 and the second surface area 316 represent approximate locations of the interposing elastomeric link bonding zones. The interposing elastomeric link may include a cast polyurethane. In some embodiments, the interposing elastomeric link is formed by the curing of polyurethane applied to the tray in fluid form.

FIG. 3C illustrates a cross sectional view of the top edge portion 304 of the tray system 104 of FIG. 3A according to some embodiments herein. The top edge portion 304 includes the first longitudinal body portion 202, the second longitudinal body portion 204, the center line 208, a topside composite support member 318, a bottomside composite support member 320, and the interposing elastomeric link 322. The topside composite support member 318 may joined along the center line 208 by the interposing elastomeric link 322 with the first longitudinal body portion 202 and the second longitudinal body portion 204. The polymer canopy portion 206 may be bonded to the topside composite support member 318 by the interposing elastomeric link 322. In some embodiments, the topside composite support member 318 is made of carbon fiber composite material 310. In some embodiments, the topside composite support member 318 is a topside composite polymer support member. In some embodiments, the bottomside composite support member 320 is a bottomside composite polymer support member. In certain alternative embodiments, at least one of the topside support member and/or the bottomside support member are comprised of steel.

The bottomside composite support member 320 may join with the first longitudinal body portion 202 and the second longitudinal body portion 204 along the center line 208 via the bonding properties of interposing elastomeric link 322. The polymer canopy portion 206 may be bonded to the bottomside composite support member 320 by the interposing elastomeric link 322. In some embodiments, the bottomside composite support member 320 is made of the carbon fiber composite material 310. The interposing elastomeric link 322 may include a polyurethane bonding layer of at least 3 mm in thickness. In some embodiments, the interposing elastomeric link 322 is formed from cast polyurethane. The interposing elastomeric link 322 may be formed by curing of polyurethane applied in the fluid form.

FIG. 3D illustrates a cross sectional view of the bottom edge portion 306 of the tray system 104 of FIG. 3A according to some embodiments herein. The bottom edge portion 306 includes the first longitudinal body portion 202, the second longitudinal body portion 204, the center line 208, the wear liner 308, the topside composite support member 318, the bottomside composite support member 320, and the interposing elastomeric link 322. Wear liner 308 may include an elastomeric material. The interposing elastomeric link 322 may include a polyurethane joint for shear strength, tensile strength, energy dissipation, and/or flexibility. The topside composite support member 318 may include a tapered edge 319.

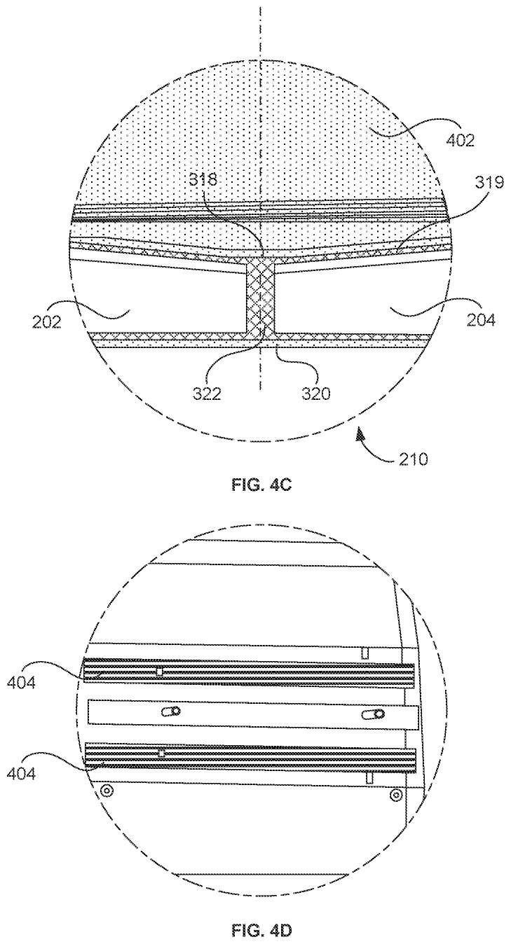

FIG. 4A and FIG. 4B illustrate the side portion 212 and a cross sectional view of the side portion 212 of the tray system 104 of FIG. 2A according to some embodiments herein. The side portion 212 of the tray system 104 includes wear liner 308, carbon fiber composite material 310, and low-density foam core 314. In some embodiments, wear liner 308 is a polyurethane wear liner. Carbon fiber composite material 310 may include carbon fiber laminate and/or wound carbon fiber resin.

FIG. 4C illustrates the bottom portion 210 of the tray system 104 of FIG. 2A according to some embodiments herein. The bottom portion 210 includes first longitudinal body portion 202, second longitudinal body portion 204, center line 208, topside composite support member 318, bottomside composite support member 320, interposing elastomeric link 322, and surface coating 402. In some embodiments, surface coating 402 is a polyurethane surface coating. The polyurethane surface coating may resist abrasion and surface wear in the tray system 104. The interposing elastomeric link 322 may comprise a polyurethane joint for shear strength, tensile strength, energy dissipation, and/or flexibility. The topside composite support member 318 may include a tapered edge 319. In some embodiments, bottom portion 210 of tray system 104 is a bonded two-piece carbon fiber laminate tray structure that includes means for connecting the tray system 104 to the support frame and/or chassis of haul truck 101.

FIG. 4D illustrates a bottom view of tray system 104 of FIG. 2A according to some embodiments herein. Tray system 104 may include a high-density foam core construction 404. The high-density foam core construction 404 may include a polycarbonate and/or a PVC high-density foam polycarbonate.

In an alternative embodiment, the tray system 104 includes a vertical connector attached between the topside support member and the bottomside composite polymer support member. The vertical connector may be joined to the first longitudinal body portion 202 and the second longitudinal body portion 204 by the interposing elastomeric link 322. In some embodiments, the at least one perforation is positioned to facilitate the interposing elastomeric link 322 formation between the first longitudinal body portion 202 and the vertical connector, and between the vertical connector and the second longitudinal body portion 204. The vertical connector may include a web portion of the I-beam structure. The topside support member and the bottomside support member may include at least one flange portion of at least one I-beam structure.

In some embodiments, the topside composite polymer support member, the vertical connector, and the bottomside support member are joined together to form an isotropic I-beam structure. The isotropic I-beam structure may transmit mechanical forces across the center line 208 of the haul truck dump tray 100. The at least one of the topside composite polymer support member, the vertical connector, and the bottomside support member may include a metallic material. The interposing elastomeric link 322 joins to and between the vertical connector, the first longitudinal body portion 202 and the second longitudinal body portion 204 along the center line 208 of the haul truck dump tray 100.

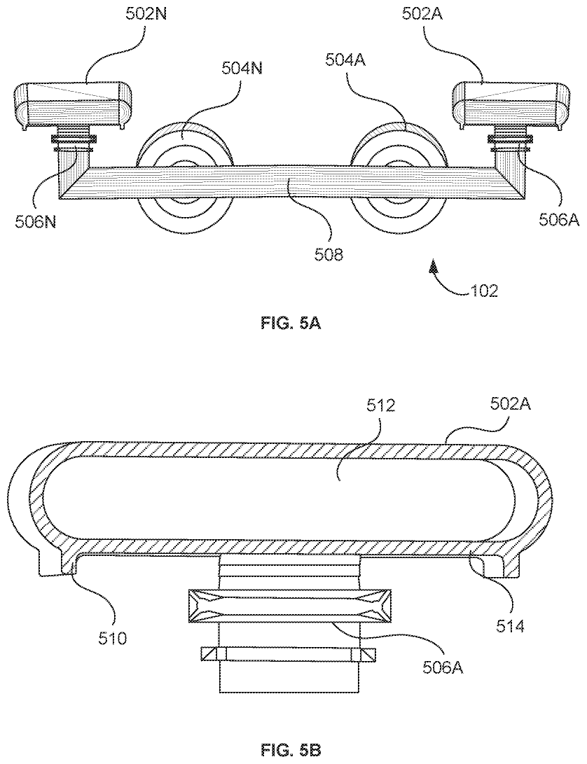

FIG. 5A illustrates a front view of the pneumatic shock absorption system 102 of FIG. 1B according to some embodiments herein. Pneumatic shock absorption system 102 includes one or more elongated compartments 502A-N, one or more air tanks 504A-N, and one or more flanges 506A-N. The one or more air tanks 504A-N store air or any other suitable gas under pressure. The one or more air tanks 504A-N may include a gas pump, e.g., and air compressor, for actively maintaining the desired pressure e.g., maintaining a nominally high or low pressure within the pneumatic shock absorption system 102 depending on the weight of the load on the haul truck dump tray 100. In some embodiments, the one or more air tanks 504A-N may be made from polyethylene or polypropylene. The one or more elongated compartments 502A-N will have a baseline pressure, and the one or more elongated compartments 502A-N may expand on receiving increasing pressure from the one or more air tanks 504A-N. The expansion of the one or more elongated compartments 502A-N may be primarily parallel to the longitudinal axis of the haul truck 101, and/or the expansion of the one or more elongated compartments 502A-N may be primarily orthogonal to the longitudinal axis of the haul truck 101. The one or more elongated compartments 502A-N may nominally lift the haul truck dump tray 100 above the one or more support members 108 at the baseline pressure in the one or more elongated compartments 502A-N. The one or more support members 108 may include one or more wound carbon fiber beams.

The one or more air tanks 504A-N may accept at least a portion of gas from the one or more elongated compartments 502A-N under a force of a load. The one or more flanges 506A-N may allow a return of at least a portion of the gas to the one or more elongated compartments 502A-N on reduction of at least a portion of the force of the load. In some embodiments, the one or more flanges 506A-N include at least one conduit or connector pipe 508. The one or more air tanks 504A-N may be connected to the one or more elongated compartments 502A-N via the at least one conduit or connector pipe 508. The at least one conduit or connector pipe 508 may include a polyethylene pipe, a polypropylene pipe, or a polyvinylchloride pipe. In some embodiments, conduit or connector pipe 508 is a compressed gas conduit.

During loading, large impact forces may strike wear liner 308 of haul truck dump tray 100, placing extreme physical stresses on haul truck dump tray 100, one or more support members 108, and/or the chassis of the haul truck 101. Accordingly, during loading pneumatic shock absorption system 102 may absorb a portion of the energy of the large impact forces via compression of gas and a concomitant increase in pressure within the one or more elongated compartments 502A-N, and/or via release of gas into the one or more air tanks 504A-N. Increased weight on the pneumatic shock absorption system 102, e.g., during loading of the haul truck dump tray 100 may supply a baseline net increasing force that increases the baseline pressure within the one or more elongated compartments 502A-N.

The one or more flanges 506A-N may release the excess pressure from the one or more elongated compartments 502A-N to the one or more air tanks 504A-N. The one or more air tanks 504A-N may accept at least a portion of the gas from the one or more elongated compartments 502A-N under the force of a load on the haul truck dump tray 100. In some embodiments, the one or more flanges 506A-N reduce pressure in the one or more elongated compartments 502A-N via release of gas when elevated pressure in the one or more elongated compartments 502A-N exceeds the baseline pressure of the one or more elongated compartments 502A-N.

When gas from the one or more elongated compartments 502A-N is released, any rebounding force of the one or more elongated compartments 502A-N may be dampened and the haul truck dump tray 100 may settle stably on the one or more support members 108. In some embodiments, subsequent increases in pressure within the one or more elongated compartments 502A-N may trigger the one or more flanges 506A-N to release gas into the one or more air tanks 504A-N, and thereby reduce the excess pressure from the haul truck dump tray 100 and e.g., act to dissipate at least a portion of the energy of the impact of loading on the haul truck dump tray 100, the one or more support members 108, the chassis, and other components of the haul truck. In some embodiments, the pneumatic shock absorption system 102 includes a pressure regulating flange that maintains a working pressure within the one or more elongated compartments 502A-N.

FIG. 5B illustrates an example view of an elongated compartment 502A with a flange 506A of FIG. 5A according to some embodiments herein. The pneumatic elongated compartment 502A includes a pneumatic bag cover 510, a pneumatic bag void 512, and a dog ear 514. In some embodiments, the pneumatic bag void 512 is an elongated compartment. The dog ear 514 may accept the support member 108 (e.g., a wound carbon fiber beam) for the placement of the elongated compartment 502A. The bottom of the elongated compartment 502A may be placed on the top of the support member 108 (e.g., the wound carbon fiber beam) and the haul truck dump tray 100 may be placed immediately on the top of the elongated compartment 502A. In some embodiments, the flange 506A selectively and/or reversibly seals a pathway from a reservoir (e.g. air tank 504A) to the elongated compartment 502A. Elongated compartment 502A may comprise any of polyurethane, rubber, nylon, woven nylon, polypropylene, polyethylene, olefin, PVC laminated and coated fabric, cloth-backed vinyl, thermoplastic films, ethyl vinyl acetate (EVA), thermoplastic polyurethane (TPU), or thermoplastic elastomers (TPE), or other appropriate material known to those of ordinary skill in the art.

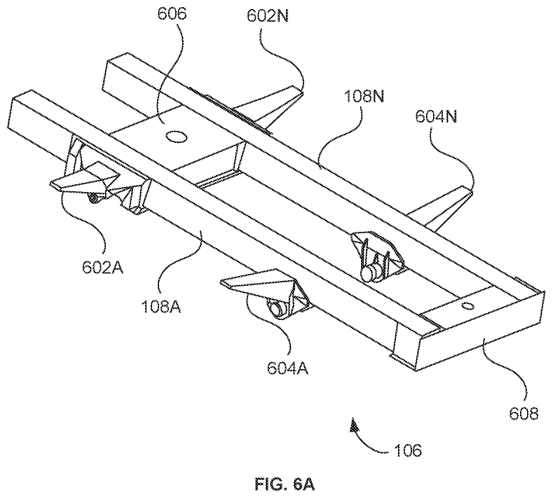

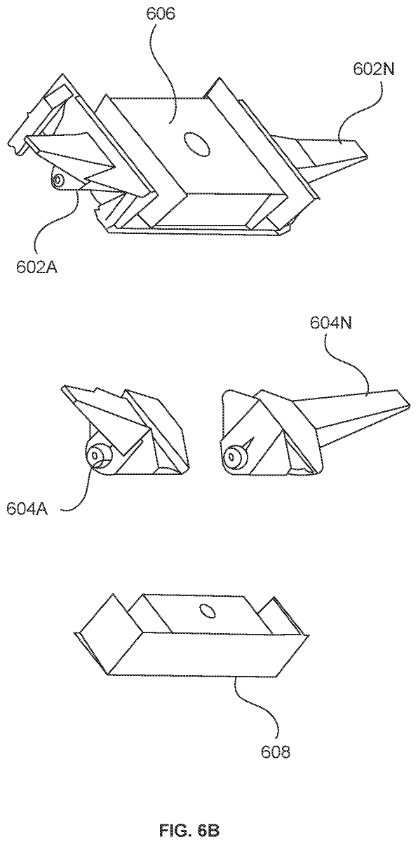

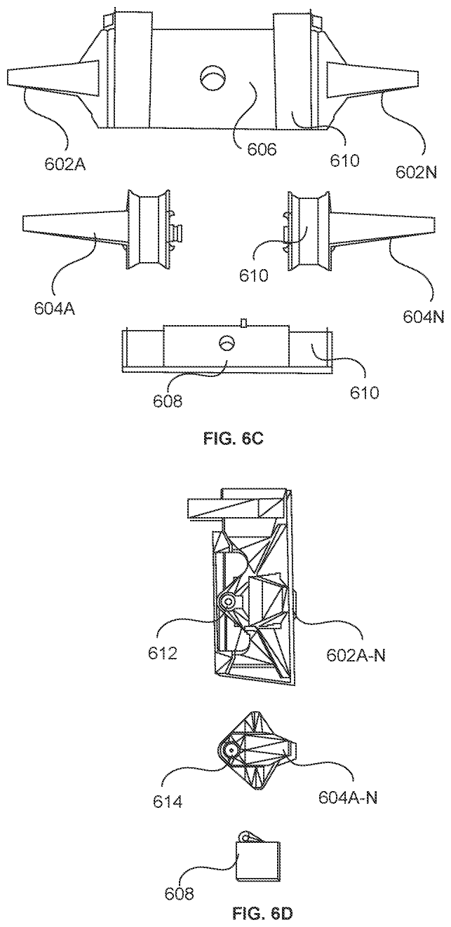

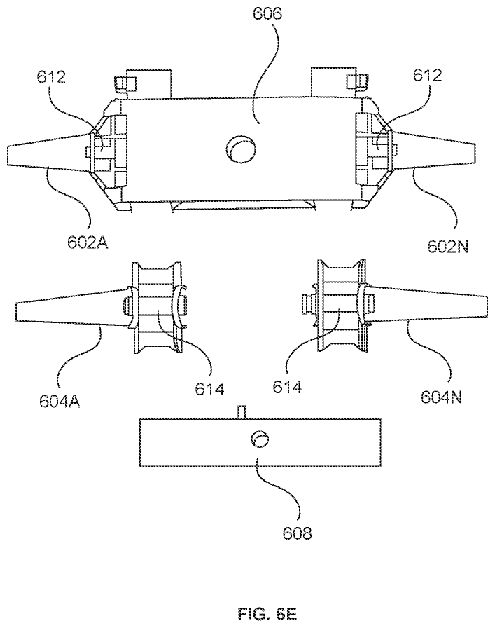

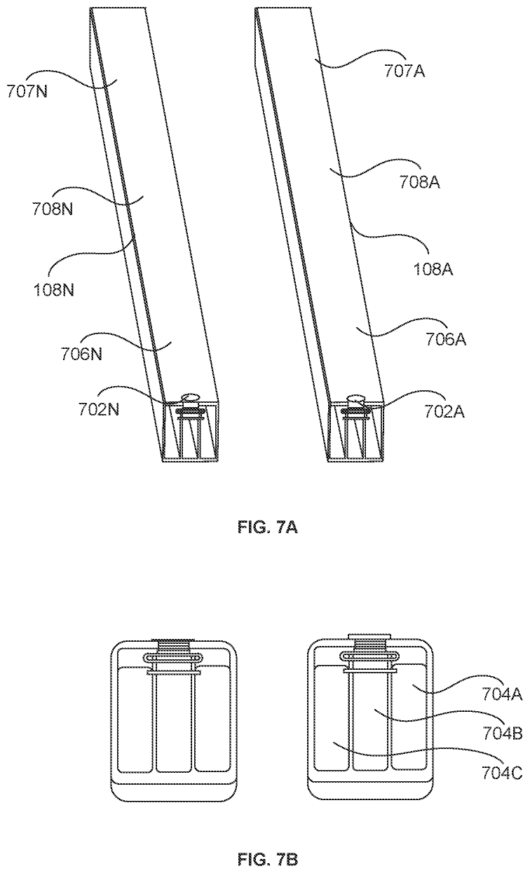

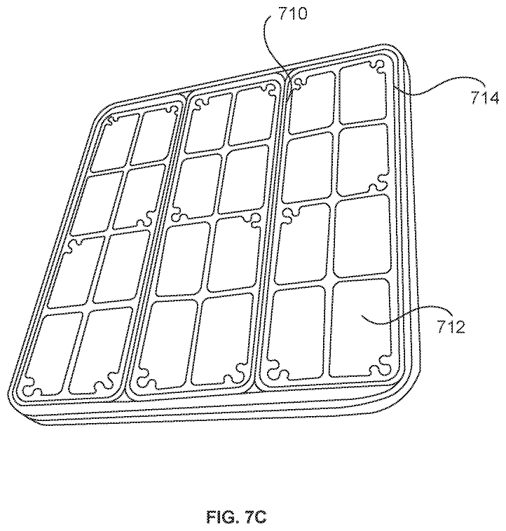

FIG. 6A illustrates a perspective view of the stabilization and tray support system 106 of FIG. 1B according to some embodiments herein. The stabilization and tray support system 106 includes one or more support members 108A-N, one or more forward outriggers 602A-N, one or more rear outriggers 604A-N, a torque box 606 and a rear frame assembly 608. The one or more support members 108A-N may include welded steel support beams. The one or more forward outriggers 602A-N and the one or more rear outriggers 604A-N provide roll stabilization support in the haul truck dump tray 100 by securing one or more points on the haul truck dump tray 100 to one or more points on the one or more support members 108A-N or chassis. In some embodiments, the one or more forward outriggers 602A-N and the one or more rear outriggers 604A-N may stabilize the side-to-side or lateral motion of the haul truck dump tray 100.

The torque box 606 may include a hole that accepts at least one tethering mechanism for limiting the extent of the separation between the one or more support members 108A-N and the one or more elongated compartments 502A-N. The rear frame assembly 608 also may include a hole that accepts at least one tethering mechanism for limiting the extent of the separation between the one or more support members 108A-N and the one or more elongated compartments 502A-N. In some embodiments, the at least one tethering mechanism may include any of a steel link, a slotted guide pin, a chain, and/or a cable. The at least one tethering mechanism may be joined at a first end to at least one of the one or more support members 108A-N, and at a second end to an underside attachment point of the haul truck dump tray 100. In some embodiments, the one or more support members 108A-N include a compression-resistant support frame extending beneath the haul truck dump tray 100 and having at least one mount via tray assembly 102 pivotally attached to the chassis of the haul truck 101.

FIGS. 6B-6E illustrate example views of components of the stabilization and tray support system 106 of FIG. 1B according to some embodiments herein. FIG. 6B illustrates a perspective view of the one or more forward outriggers 602A-N, the one or more rear outriggers 604A-N, the torque box 606, and the rear frame assembly 608. The functions and operations of the components are as explained above. FIG. 6C illustrates a top view of the one or more forward outriggers 602A-N, the one or more rear outriggers 604A-N, the torque box 606, and the rear frame assembly 608. The one or more forward outriggers 602A-N and the torque box 606 may include a channel 610 for accepting the one or more support members 108A-N. FIGS. 6D and 6E illustrate a side view and a bottom view respectively of the one or more forward outriggers 602A-N, the one or more rear outriggers 604A-N, the torque box 606 and the rear frame assembly 608. The one or more forward outriggers 602A-N may include a hydraulic mount 612 for attaching the haul truck dump tray 100 to a point on the chassis of the haul truck 101. The hydraulic mount 612 may attach the haul truck dump tray 100 pivotally to the chassis of the haul truck 101. The one or more rear outriggers 604A-N may include a chassis tray mount 614 for attaching the haul truck dump tray 100 to the chassis of the haul truck 101. In some embodiments, the chassis tray mount 614 is a pivot location for attaching the haul truck dump tray 100 to the chassis the haul truck 101. The one or more rear outriggers 604A-N may include attachment means on a subframe of the haul truck dump tray 100 that is pivotally attached to the chassis of the haul truck 101.

FIGS. 7A and 7B illustrate a perspective view and a back view respectively of the one or more steel support members 108A-N of FIG. 1B according to some embodiments herein. The one or more support members 108A-N include one or more plumbing elements 702A-N for providing gas flow for cushioning haul truck dump tray 100. In some embodiments, the one or more plumbing elements 702A-N are plumbing conduit(s) for the one or more elongated compartments 502A-N. In some embodiments, the one or more support members 108A-N may include welded steel support beams.

The one or more support members 108A-N may include one or more structural support chambers 704A-N, and one or more outrigger locations 708A-N. In some embodiments, the one or more structural support chambers 704A-N may include any of a first chamber 704A, a second chamber 704B, and/or a third chamber 704C.

FIG. 7C illustrates an example view of the one or more areas of structural steel of FIG. 7A according to some embodiments herein.

### CLAUSES

38. A haul truck dump tray comprising:
a first longitudinal body portion and a second longitudinal body portion joined along a center line by an elastomeric link extending along the center line and bonded to and between them;
a topside support member spanning the center line and joined by an elastomeric link to the first and second longitudinal body portions;
a bottomside support member spanning the center line and joined by an elastomeric link to the first and second longitudinal body portions; and
a vertical connector attached to the topside support member and the bottomside support member, wherein the vertical connector is joined by an elastomeric link to the first and second longitudinal body portions.
   39. The haul truck dump tray of clause 38 further comprising a polymer canopy portion bonded to a top edge portion of each of the first and second longitudinal body portions by an elastomeric link that extends across a width of the first and second longitudinal body portions.
   40. The haul truck dump tray of clause 38, wherein the vertical connector includes at least one perforation, wherein the at least one perforation is positioned to facilitate elastomeric link formation between the first longitudinal body portion and the vertical connector, and between the vertical connector and the second longitudinal body portion.
   41. The haul truck dump tray of clause 39, wherein a canopy joining member interposes the polymer canopy portion and the first longitudinal body portion and the second longitudinal body portion, and wherein an elastomeric link joins the polymer canopy portion to the canopy joining member and the first longitudinal body portion and the second longitudinal body portion.
   42. The haul truck dump tray of clause 39 wherein the polymer canopy portion comprises a low density foam core, the low density foam core having a surface area portion covered by a layer of a carbon fiber composite material.
   43. The haul truck dump tray of clause 39 or claim 41 wherein the polymer comprises at least one of an aerospace grade carbon fiber composite material or an industrial grade carbon fiber composite material.
   44. The haul truck dump tray of clause 38 wherein the first longitudinal body portion and the second longitudinal body portions are comprised of a foam core covered by one or more carbon fiber polymer surface layers.
   45. The haul truck dump tray of clause 38 wherein the topside composite support member and the bottomside composite support member are made of a carbon fiber composite material.
   46. The haul truck dump tray of clause 38 or claim 40, wherein the elastomeric link is comprised of polyurethane.
   47. The haul truck dump tray of clause 38 or claim 40, wherein the elastomeric link is formed by a curing of a urethane applied in fluid form.
   48. The haul truck dump tray of clause 38 or 40, further comprising a wear liner comprised of an elastomeric material having a thickness of from about 90 to about 100 mm.
   49. The haul truck dump tray of clause 38 or 40, wherein the topside support member, the vertical connector, and the bottomside support member together form an I-beam structure.
   50. The haul truck dump tray of clause 49, wherein the I-beam structure is made of at least one of a composite material, a carbon fiber material, or a metallic material.
   51. The haul truck dump tray of clause 49, wherein the I-beam structure comprises steel.
   52. The haul truck dump tray of clause 51, wherein two or more I-beam structures arranged end-to-end longitudinally along the tray form a substantially continuous I-beam structure.
   53. The haul truck dump tray of clause 38 or 40, wherein the topside support member and the bottomside support member are each angled about 5 degrees upward from a bottom horizontal plane of the tray.
   54. The haul truck dump tray of clause 38 or 40, wherein the topside support member, the vertical connector, and the bottomside support member together form an isotropic I-beam structure operable to transmit mechanical forces across a centerline of the tray.
   55. The haul truck dump tray of clause 39 or 40, wherein at least one of the topside support member, the vertical connector, and the bottomside support member comprise a metallic material.
   56. The haul truck dump tray of clause 38 or 49, wherein the vertical connector comprises a web portion of an I-beam structure.
   57. The haul truck dump tray of clause 38 or 49, wherein the topside support member and the bottomside support member each comprise at least one flange portion of at least one I-beam structure.
   58. A haul truck dump tray comprising:
a first longitudinal body portion and a second longitudinal body portion, wherein each of the first and second longitudinal body portions further comprises:
   a top carbon fiber laminate surface;
   an opposing bottom carbon fiber laminate surface;
   a foam core, the foam core disposed between the top carbon fiber laminate surface and the opposing bottom carbon fiber laminate surface;
   at least one angled portion proximate to a center line of the tray, wherein the angled portion of the first longitudinal body portion and the angled portion of second longitudinal body portion form a channel whereby their edges approach each other along the center line of the tray;
a topside support member residing at least partially within the channel; and
a bottomside support member positioned approximately parallel to the topside support member;
a vertical connector attached to the topside support member and the bottomside support member;
an elastomeric link, wherein the elastomeric link joins to and between at least:
   the first longitudinal body portion and a second longitudinal body portion along at least one face of the angled portion;
   the topside support member, the first longitudinal body portion, and the second longitudinal body portion;
   the bottomside support member, the first longitudinal body portion, and the second longitudinal body portion along the center line of the tray; and
   the vertical connector, the first longitudinal body portion, and the second longitudinal body portion along the center line of the tray.
      59. The haul truck dump tray of clause 58, wherein the foam core comprises a low-density foam core.
      60. The haul truck tray of clause 58, wherein the top carbon fiber laminate surface and the opposing bottom carbon fiber laminate surface further comprise at least one location of a high-density foam core, wherein the at least one location of the high-density foam core is positioned to at least one of absorb or dissipate a concentrated force load relative to other areas of the tray.
      61. The haul truck tray of clause 58, wherein the foam core comprises a high-density foam core.
      62. The haul truck dump tray of clause 58 further comprising a wear liner made of an elastomeric material.
      63. The haul truck dump tray of clause 58 further comprising a compression-resistant support frame extending beneath the haul truck dump tray and having at least one mount via which the haul truck dump tray may be pivotally attached to a haul truck chassis, and at least one cushioning element interposing the haul truck dump tray and the compression-resistant support frame.
      64. The haul truck dump tray of clause 58 further comprising a canopy joining member, wherein the canopy joining member interposes the polymer canopy portion and the first longitudinal body portion and the second longitudinal body portion, and wherein an elastomeric link joins the polymer canopy portion to the canopy joining member and the first longitudinal body portion and the second longitudinal body portion.
      65. The haul truck dump tray of clause 58, wherein the elastomeric link has a thickness of at least 1 mm.
      66. The haul truck dump tray of clause 58, wherein the elastomeric link has a thickness of at least 2 mm.
      67. The haul truck dump tray of clause 58, wherein the elastomeric link has a thickness of at least 3 mm.
      68. The haul truck dump tray of clause 58, further comprising at least one pivot assembly.
      69. The haul truck dump tray of clause 58, further comprising a hoisting mechanism assembly.
      70. The haul truck dump tray of clause 58, further comprising a pneumatic compression system positioned between the haul truck dump tray and the compression-resistant support frame.
      71. The haul truck dump tray of clause 58, further comprising at least one of a steel tray support structure; a support structure with one or more outriggers configured to provide roll stabilization support; a support structure having at least one location for accepting a pivot mechanism connection; or a support structure having at least one location for accepting a hoisting mechanism connection.
      72. The haul truck dump tray of clause 51, wherein the vertical connector is welded to the topside support member and the bottomside support member to form an I-beam structure.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the appended claims.

We claim:

1. A haul truck dump tray comprising:
a first longitudinal body portion and a second longitudinal body portion joined along a center line by an interposing elastomeric link extending along the center line and bonded to and between them;
a topside support member joined along the center line by the interposing elastomeric link to the first longitudinal body portion and the second longitudinal body portion; and
a bottomside support member joined along the center line by the interposing elastomeric link to the first longitudinal body portion and the second longitudinal body portion.

2. The haul truck dump tray of claim 1 further comprising a polymer canopy portion bonded to a top edge portion of each of the first longitudinal body portion and the second longitudinal body portion by the interposing elastomeric link that extends across a width of the joined first longitudinal body portion and the second longitudinal body portion.

3. The haul truck dump tray of claim 2, wherein the polymer canopy portion is further bonded by the interposing elastomeric link to the topside support member and the bottomside composite polymer support member.

4. The haul truck dump tray of claim 2, wherein a canopy joining member interposes the polymer canopy portion and the first longitudinal body portion and the second longitudinal body portion, and wherein the interposing elastomeric link joins the polymer canopy portion to the canopy joining member and the first longitudinal body portion and the second longitudinal body portion.

5. The haul truck dump tray of claim 2 wherein the polymer canopy portion comprises a low-density foam core, the low-density foam core having a surface area portion covered by a layer of a carbon fiber composite material.

6. The haul truck dump tray of claim 1 or claim 2 wherein the polymer canopy portion comprises at least one of an aerospace grade carbon fiber composite material or industrial grade carbon fiber composite material.

7. The haul truck dump tray of claim 1, wherein the first longitudinal body portion and the second longitudinal body portion are comprised of a foam core covered by one or more carbon fiber polymer surface layers.

8. The haul truck dump tray of claim 1 wherein the topside support member and the bottomside support member are made of a carbon fiber composite material.

9. The haul truck dump tray of claim 1 or claim 2, wherein the interposing elastomeric link is comprised of polyurethane.

10. The haul truck dump tray of claim 1 or claim 2, wherein the interposing elastomeric link is formed by a curing of a urethane applied in fluid form.

11. The haul truck dump tray of claim 1 or 2, further comprising a wear liner comprised of an elastomeric material.

12. The haul truck dump tray of claim 11, wherein the elastomeric material comprises cast polyurethane.

13. The haul truck dump tray of claim 1 or 2, wherein the elastomeric material forms a polyurethane bonding layer of at least 3 mm in thickness.

14. The haul truck dump tray of claim 1 or 2, wherein the first longitudinal body portion and the second longitudinal body portion comprise substantially two respective longitudinal halves of the haul truck dump tray.

15. The haul truck dump tray of claim 14, wherein each of the first longitudinal body portion and the second longitudinal body portion comprises a portion of a floor of the haul truck dump tray, a portion of a front wall of the haul truck dump tray, and a portion of a side wall of the haul truck dump tray.

16. The haul truck dump tray of claim 4, wherein the canopy joining member comprises an elongate body, the elongate body of the canopy joining member having a first channel or a groove positioned to receive joining portions respectively of the first longitudinal body portion and the second longitudinal body portion.

17. The haul truck dump tray of claim 16, wherein the canopy joining member further comprises a second channel or a groove positioned to receive a joining portion of the polymer canopy portion.

18. The haul truck dump tray of claim 16 or claim 17, wherein the polymer canopy portion, the canopy joining member, the first longitudinal body portion, and the second longitudinal body portion are joined via the interposing elastomeric link.

19. A haul truck dump tray comprising (1) a carbon fiber composite and foam core composite structure lined with an elastomeric material; (2) a canopy; (3) a pivot assembly; and (4) a hoist assembly.

20. A haul truck dump tray comprising two longitudinal halves, each of the two longitudinal halves comprising carbon polymer tray portions having substantially matching edges, and joined along the matching edges by an interposing elastomeric link extending along the matching edges and bonded to and between them.

21. The haul truck dump tray of claim 19 further comprising a wear liner made of an elastomeric material.

22. A haul truck dump tray assembly comprising the tray of claim 1 or 2, a compression-resistant support frame extending beneath the haul truck dump tray and having at least one mount via which the haul truck dump tray assembly can be pivotally attached to a haul truck chassis, and at least one cushioning element interposing the haul truck dump tray and the support frame.

23. A haul truck comprising a chassis pivotally attached to the haul truck dump tray assembly of claim 22.

24. A haul truck dump tray comprising:
a first longitudinal body portion and a second longitudinal body portion, wherein each of the first longitudinal body portion and the second longitudinal body portion further comprises:
a top carbon fiber laminate surface;
an opposing bottom carbon fiber laminate surface;
a foam core, the foam core disposed between the top carbon fiber laminate surface and the opposing bottom carbon fiber laminate surface;
at least one angled portion proximate to a center line of the haul truck dump tray, wherein the angled portion of the first longitudinal body portion and the angled portion of second longitudinal body portion form a channel where their edges approach each other along the center line of the haul truck dump tray;
a topside support member residing at least partially within the channel; and
a bottomside support member positioned approximately parallel to the topside support member; and
a continuous elastomeric link, wherein the continuous elastomeric link joins to and between at least:
the first longitudinal body portion and the second longitudinal body portion along a face of the angled portion;
the topside support member, the first longitudinal body portion, and the second longitudinal body portion; and
the bottomside support member, the first longitudinal body portion, and the second longitudinal body portion along the center line of the haul truck dump tray.

25. The haul truck dump tray of claim 24, wherein the foam core is a low-density foam core.

26. The haul truck dump tray of claim 24, wherein the top carbon fiber laminate surface and the opposing bottom carbon fiber laminate further comprises at least one location of a high-density foam core, wherein the at least one location of the high-density foam core is positioned to absorb a concentrated force load relative to other areas of the haul truck dump tray.

27. The haul truck dump tray of claim 24, wherein the foam core is a high-density foam core.

28. The haul truck dump tray of claim 24 further comprising a wear liner made of an elastomeric material.

29. The haul truck dump tray of claim 24 further comprising a compression-resistant support frame extending beneath the haul truck dump tray and having at least one mount via which the haul truck dump tray can be pivotally attached to a haul truck chassis, and at least one cushioning element interposing the haul truck dump tray and the support frame.

30. The haul truck dump tray of claim 24 further comprising a canopy joining member, wherein the canopy joining member interposes the polymer canopy portion and the first longitudinal body portion and the second longitudinal body portion, and wherein the continuous elastomeric link joins the polymer canopy portion to the canopy joining member and the first longitudinal body portion and the second longitudinal body portion.

31. The haul truck dump tray of claim 24, wherein the continuous elastomeric link has a thickness of at least 1 mm.

32. The haul truck dump tray of claim 24, wherein the continuous elastomeric link has a thickness of at least 2 mm.

33. The haul truck dump tray of claim 24, wherein the continuous elastomeric link has a thickness of at least 3 mm.

34. The haul truck dump tray of claim 24, further comprising at least one pivot assembly.

35. The haul truck dump tray of claim 24, further comprising a hoisting mechanism assembly.

36. The haul truck dump tray of claim 24, further comprising a pneumatic compression system.

37. The haul truck dump tray of claim 24, further comprising at least one of a steel tray support structure; a support structure with one or more outriggers configured to provide roll stabilization support; or a support structure having at least one location for accepting a pivot mechanism connection and at least one location for accepting a hoisting mechanism connection.
